(19) United States
(12) Patent Application Publication
(10) Pub. No.: US 2015/0290549 A1
(43) Pub. Date: Oct. 15, 2015

(54) SLIDING GEAR MESH

(71) Applicant: ARRMA DURANGO LTD, Ashby-de-la-Zouch (GB)

(72) Inventors: Fabien Simonini, Shepshed (GB); Jason Dearden, Ashby-de-la-Zouch (GB); Ben Cosgrove, Shepshed (GB)

(21) Appl. No.: 14/684,637

(22) Filed: Apr. 13, 2015

Related U.S. Application Data
(60) Provisional application No. 61/978,300, filed on Apr. 11, 2014.

(51) Int. Cl. A63H 17/26; F16H 48/40; F16H 57/12

(52) U.S. Cl. CPC A63H 17/262; F16H 57/12; F16H 48/40

(57) ABSTRACT

According to an embodiment, a sliding gear mesh includes a chassis, a prime mover mounted on the chassis and fixed in position relative to the chassis, a prime drive gear coupled with the prime mover and driven to rotate by the prime mover, and a sliding gear assembly. The sliding gear assembly includes a sliding drive gear that meshes with the prime drive gear. The sliding gear assembly is slidably mounted on the chassis to slide toward and away from the prime drive gear to adjust a mesh between the sliding drive gear and the prime drive gear.

### CROSS-REFERENCE TO RELATED APPLICATION

This application claims priority to provisional patent application No. 61/978,300 entitled “Sliding Gear Mesh” and filed on Apr. 11, 2014, the contents of which are hereby incorporated by reference in their entirety.

### BACKGROUND

1. Field

This disclosure relates generally to power trains for model vehicles, and, more particularly, to a sliding gear mesh between a motor or engine and a gear.

2. Description of the Related Art

In order to adjust gear mesh between a prime mover, for example, an electric motor or combustion engine, and a primary spur gear of a differential in model vehicles (e.g., ⅛ scale nitro and electric powered model vehicles), the distance between the axis of the prime mover and the primary spur gear needs to be adjustable. In conventional systems, the gear mesh is either not adjustable, or the prime mover is moved sideways in relation to a chassis on which both the prime mover and the differential are mounted in order to adjust the mesh between the pinion/end-bell gear of the prime mover and the spur gear of the differential. In these conventional systems, the differential is fixed in position on the chassis.

### SUMMARY

According to an embodiment, a sliding gear mesh includes a chassis, a prime mover mounted on the chassis and fixed in position relative to the chassis, a prime drive gear coupled with the prime mover and driven to rotate by the prime mover, and a sliding gear assembly. The sliding gear assembly includes a sliding drive gear that meshes with the prime drive gear. The sliding gear assembly is slidably mounted on the chassis to slide toward and away from the prime drive gear to adjust a mesh between the sliding drive gear and the prime drive gear.

The prime mover may include a motor.

The prime mover may include an engine.

The sliding drive gear may include a spur gear.

The sliding drive gear may be rotationally coupled with an axle to rotate the axle about an axis of rotation when the sliding drive gear rotates about the same axis of rotation.

The sliding drive gear may be rotationally coupled with a differential to rotate a pair of axles along a common axis of rotation when the sliding drive gear rotates.

The prime mover may be fixedly mounted on the chassis by a plurality of fasteners.

The plurality of fasteners may include a fixing fastener that passes through a substantially symmetrical hole in the chassis.

The substantially symmetrical hole may be slightly larger than a width of the fixing fastener to constrain lateral movement of the fixing fastener relative to the chassis.

The fixing fastener may include a fastener selected from the group consisting of a screw, a rivet, a bolt, a nut, a lever, a knob, a clamp, a clip, a latch, toggle fastener, and a pin.

The sliding gear assembly may be mounted on the chassis by a fixing fastener.

The fixing fastener may alternately fix the sliding gear assembly in position relative to the chassis by friction between the chassis and the sliding gear assembly when the fixing fastener is in a tightened state and facilitate lateral movement of the sliding gear assembly relative to the chassis and prime drive gear when the fixing fastener is in a loosened state.

The fixing fastener may pass through a substantially oblong hole in a sliding plate of the sliding gear assembly and fasten to the chassis, the fixing fastener alternately fixing the sliding gear assembly in position relative to the chassis when the fixing fastener is in a tightened state and facilitating lateral movement of the sliding gear assembly relative to the chassis and prime drive gear when the fixing fastener is in a loosened state.

The oblong hole may be slightly larger than a width of the fixing fastener in a first direction and significantly larger than a width of the fixing fastener in a second direction perpendicular to the first direction to substantially restrict the lateral movement of the fixing fastener relative to the chassis and prime drive gear to the second direction.

The second direction is aligned to guide lateral movement of the sliding drive gear toward and away from the prime drive gear.

The fixing fastener may include a fastener selected from the group consisting of a screw, a rivet, a bolt, a nut, a lever, a knob, a clamp, a clip, a latch, toggle fastener, and a pin.

The prime drive gear may be fixed in position relative to the prime mover.

According to another embodiment, a method of adjusting a mesh between a prime drive gear of a prime mover and a sliding drive gear of a sliding gear assembly is performed where the prime mover is mounted on a chassis and fixed in position relative to the chassis, the prime drive gear is coupled with the prime mover and driven to rotate by the prime mover, and the sliding gear assembly comprising the sliding drive gear is slidably mounted on the chassis to slide toward and away from the prime drive gear. The method includes loosening a fixing fastener that fastens the sliding gear assembly to the chassis, sliding the sliding gear assembly toward or away from the prime mover, and tightening the fixing fastener that fastens the sliding gear assembly to the chassis.

Sliding the sliding gear assembly may include sliding the fixing fastener along a length of an oblong hole in a sliding plate of the sliding gear assembly that is aligned to guide lateral movement of the sliding drive gear toward and away from the prime drive gear.

Sliding the sliding gear assembly may include sliding the fixing fastener along a guide rail that is aligned to guide lateral movement of the sliding drive gear toward and away from the prime drive gear.

### BRIEF DESCRIPTION OF THE DRAWINGS

Features and advantages of this disclosure will become apparent in review of exemplary embodiments with reference to the attached drawings, in which:

FIGS. 1A and 1B are angled views from different angles that illustrate a sliding assembly including a primary spur gear, according to an embodiment;

FIGS. 2A and 2B are angled views from different angles and FIG. 2C is a top view that illustrate a sliding assembly including a primary spur gear coupled with a throttle/brake servo, according to an embodiment;

FIG. 3A is an angled view that illustrates an electric motor assembly, according to an embodiment;

FIG. 3B is an angled view that illustrates an engine assembly, according to an embodiment;

FIG. 4A is a top view that illustrates two alternate positions of a sliding assembly mounted on a chassis and coupled with a motor fixed in relation to the chassis, according to an embodiment;

FIG. 4B is an angled view that illustrates a sliding assembly mounted on a chassis and coupled with a motor fixed in relation to the chassis, according to an embodiment;

FIG. 5A is a bottom view that illustrates a bottom of the chassis with which the sliding assembly and the motor of FIGS. 4A and 4B are coupled, according to an embodiment;

FIG. 5B is a bottom view with the chassis removed showing the relative positions of the sliding assembly and the motor of FIGS. 4A and 4B when they are coupled with the chassis, according to an embodiment;

FIG. 6A is a top view that illustrates two alternate positions of a sliding assembly mounted on a chassis and coupled with an engine fixed in relation to the chassis, according to an embodiment;

FIG. 6B is an angled view that illustrates a sliding assembly mounted on a chassis and coupled with an engine fixed in relation to the chassis, according to an embodiment;

FIG. 7A is a bottom view that illustrates a bottom of the chassis with which the sliding assembly and the engine of FIGS. 6A and 6B are coupled, according to an embodiment;

FIG. 7B is a bottom view with the chassis removed showing the relative positions of the sliding assembly and the engine of FIGS. 6A and 6B when they are coupled with the chassis, according to an embodiment;

FIG. 8 is a bottom view that illustrates a bottom of a chassis with which a sliding assembly and a prime mover are coupled, according to an embodiment; and

FIG. 9 is a flow chart of a method of adjusting a mesh between a prime drive gear of a prime mover and a sliding drive gear of a sliding gear assembly, according to an embodiment.

### DETAILED DESCRIPTION

Model vehicles, for example, ⅛ scale radio control cars, include a gear mesh in their drive train to drive wheels using a prime mover. The prime mover may include a combustion engine, for example, a nitro engine, or an electric motor. The drive train may also include a center differential having a drive gear or primary spur gear that couples with a gear of the prime mover, for example a pinion/end-bell gear. In order to adjust gear mesh between the gear of the prime mover and the primary spur gear, the distance between the axis of those two items needs to be adjustable. In an embodiment, the distance is adjusted by moving the center differential that includes the primary spur gear sideways toward or away from the gear of the prime mover to achieve a correct mesh between the gear of the prime mover and the primary spur gear. The center differential may be moveable in position toward or away from the pinion/end-bell gear of the prime mover relative to a chassis on which both the prime mover and the center differential are mounted, while the prime mover is fixed in position relative to the chassis.

The principles of the embodiments of the sliding gear mesh are as follows:

The prime mover (e.g., combustion engine or electric motor) is fixed to the chassis and its position in relation to the chassis is not adjustable.

The primary spur gear is also fixed to the chassis, but its position relative to the chassis is adjustable in order to allow the distance between the prime mover and the primary spur gear to be adjusted, for example, by being manually adjusted. The assembly of parts that move together when the gear mesh is adjusted is referred to as a “sliding assembly.”

In the case of a combustion engine being used in the model vehicle, a servo controlling the throttle and/or brakes can also be included in the sliding assembly so that its position relative to the primary spur gear is fixed. This would ensure that the linkages between throttle servo and brake levers do not change when the gear mesh is adjusted.

While the embodiments discussed herein refer to a primary spur gear and a center differential, this should not be construed as limiting, as the primary gear that moves toward or away from the gear of the prime mover may take other forms as known in the art besides a spur gear in various embodiments. Other types of gears as known in the art may be used include a ring gear, helical gear, skew gear, bevel gear, or worm gear, for example. Therefore, the primary gear of the sliding assembly may also be referred to as a drive gear of the sliding assembly. In addition, in some embodiments, the primary gear may be rotationally coupled with an axle to rotate the axle about an axis of rotation without using a differential. The primary gear may rotate the axle about the same axis of rotation about which the primary gear rotates.

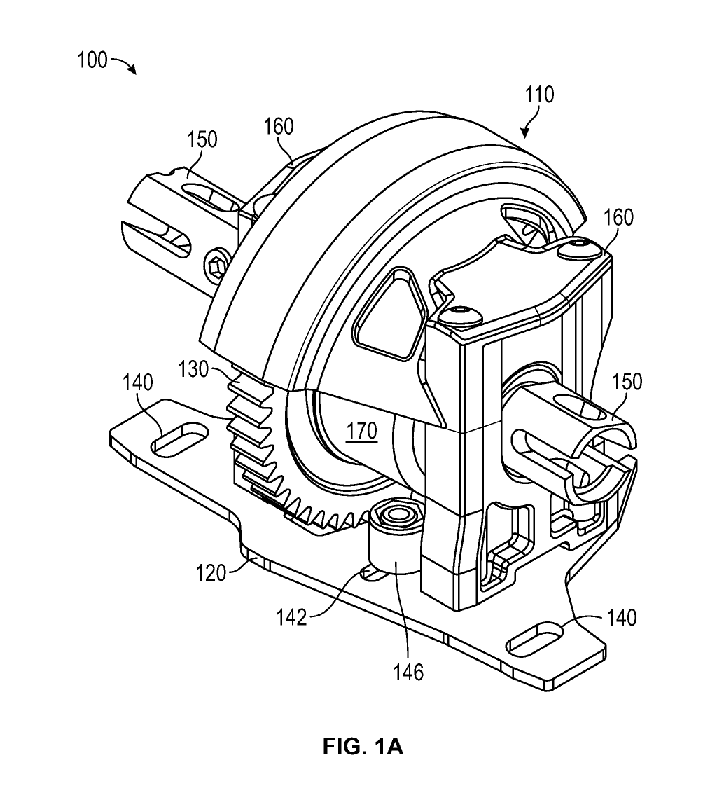

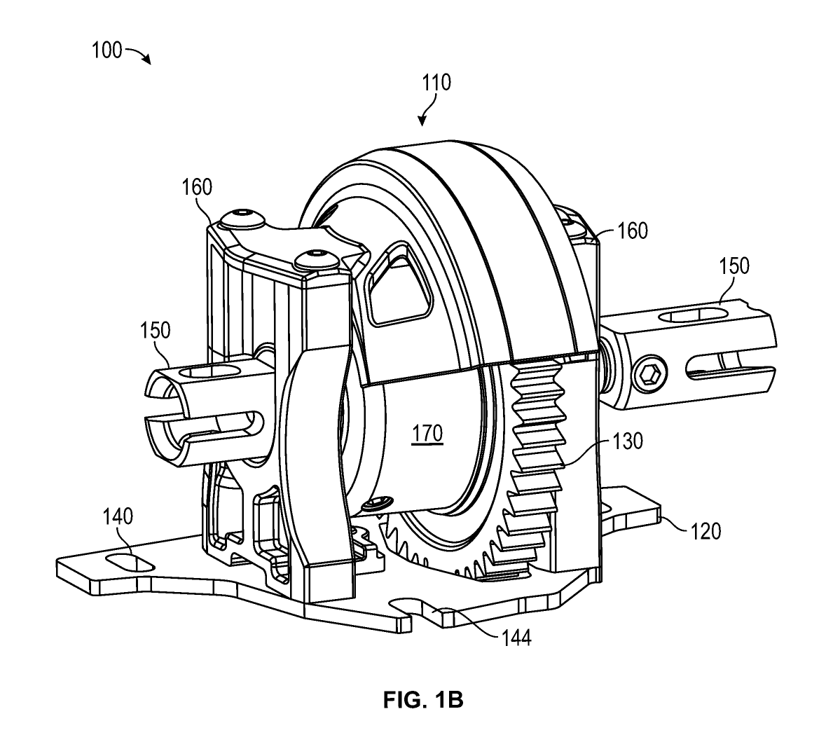

FIGS. 1A and 1B are views from different angles that illustrate a sliding assembly 100 including a primary spur gear 130, according to an embodiment. The primary spur gear 130 may be mounted within a primary spur gear assembly 110 that also includes axles 150 mounted in axle mounts 160 to hold the primary spur gear 130 in place. When the primary spur gear 130 turns, the axles 150 may turn in a same direction. The axles 150 may be aligned along a same axis of rotation as the primary spur gear 130, such that the axles 150 rotate about the same axis of rotation about which the primary spur gear 130 rotates. In an embodiment, the primary spur gear assembly 110 may include a differential gear carrier 170. The primary spur gear assembly 110 includes the primary spur gear 130 and a sliding plate 120 to which the primary spur gear assembly 110 is affixed.

The sliding plate 120 includes fastening holes 140, 142, and 144 through which fasteners, for example, screws, rivets, bolts, knobs, pins, protrusions, or other fasteners as known in the art may be inserted to fasten the sliding plate 120 to a chassis. Other fasteners that may replace or supplement the fasteners that are inserted into the fastening holes 140, 142, and 144 include nuts, levers, clamps, clips, latches, and toggle fasteners. The fasteners may alternately fix the sliding plate 120 in position relative to the chassis by friction between the chassis and the sliding plate 120 when the fasteners are in a tightened state and facilitate lateral movement of the sliding plate 120 relative to the chassis and prime mover when the fasteners are in a loosened state. Sliding assembly fastener 146 is an embodiment of a fastener that passes through fastening hole 142. A fastener may be inserted through the fastening hole 144 to fasten the sliding plate 120 to the chassis while at the same time fastening a motor to the chassis. An open notch on an outer end of the fastening hole 144 facilitates the sliding plate 120 to be removed from the chassis without fully removing the fastener that fastens both the motor and the sliding plate 120 via the fastening hole 144.

The fastening holes 140, 142, and 144 may be oblong and aligned to guide lateral movement of the sliding plate 120 and the primary spur gear assembly 110 toward and away from the motor to adjust a mesh between the primary spur gear 130 and a gear of the motor. The fastening holes 140, 142, and 144 may be considered oblong because they are slightly larger than a width of the fastener in a first direction and significantly larger than a width of the fastener in a second direction perpendicular to the first direction to substantially restrict the lateral movement of the fastener relative to the chassis and motor to the second direction. The holes may be considered slightly larger than a width of the fastener when they are less than twice the width of the fasteners and/or the fasteners are able to secure the sliding plate 120 in place on the chassis because of how narrow the fastening holes 140, 142, and 144 are relative to the fasteners. The holes may be considered significantly larger than the width of the fasteners in a second direction perpendicular to the first direction when the holes are longer than twice the width of the fasteners, the holes are visibly longer in the second direction than they are wide in the first direction, and/or the holes facilitate sufficient movement of the sliding plate 120 relative to the chassis along the second direction to measurably adjust the mesh between the primary spur gear 130 and the gear of the motor without detrimental skewing of the sliding plate 120 along the first direction.

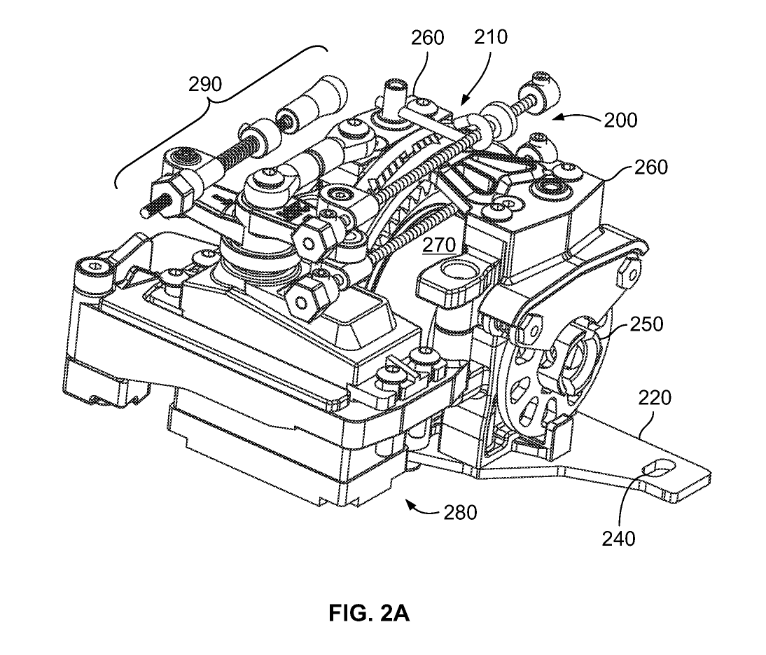

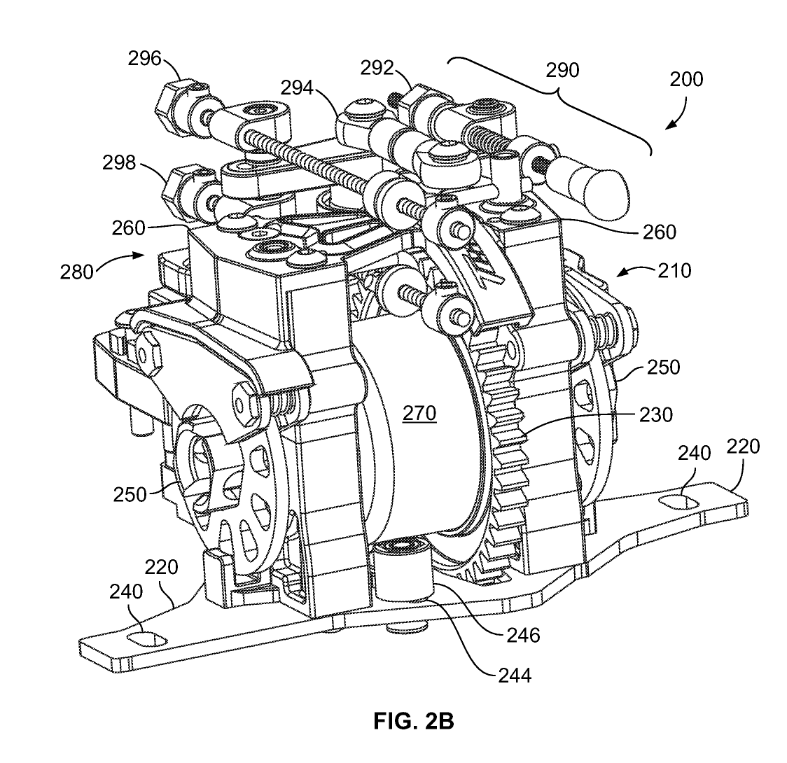

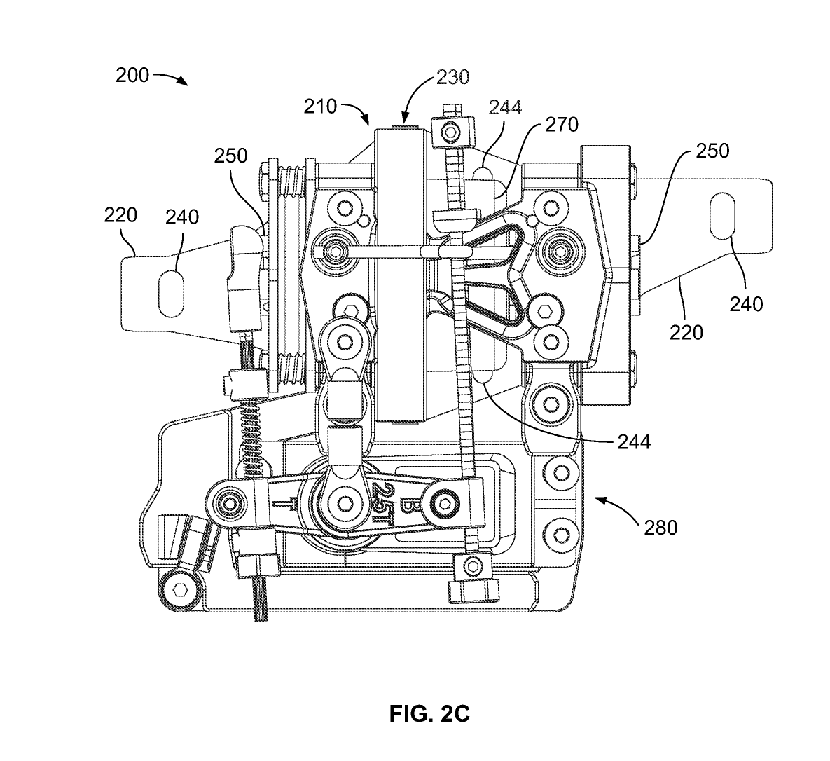

FIGS. 2A and 2B are views from different angles and FIG. 2C is a top view that illustrate a sliding assembly 200 including a primary spur gear 230 coupled with a throttle/brake servo 280, according to an embodiment. The primary spur gear 230 may be mounted within a primary spur gear assembly 210 that also includes axles 250 mounted in axle mounts 260 to hold the primary spur gear 230 in place. When the primary spur gear 230 turns, the axles 250 may turn in a same direction. The axles 250 may be aligned along a same axis of rotation as the primary spur gear 230. In an embodiment, the primary spur gear assembly 210 may include a differential gear carrier 270. The primary spur gear assembly 210 includes the primary spur gear 230 and a sliding plate 220 to which the primary spur gear assembly 210 is affixed.

The sliding plate 220 includes fastening holes 240 and 244 through which fasteners, for example, screws, rivets, bolts, knobs, pins, protrusions, or other fasteners as known in the art may be inserted to fasten the sliding plate 220 to a chassis. Other fasteners that may replace or supplement the fasteners that are inserted into the fastening holes 240 and 244 include nuts, levers, clamps, clips, latches, and toggle fasteners. The fasteners may alternately fix the sliding plate 220 in position relative to the chassis by friction between the chassis and the sliding plate 220 when the fasteners are in a tightened state and facilitate lateral movement of the sliding plate 220 relative to the chassis and prime mover when the fasteners are in a loosened state. Sliding assembly fastener 246 is an embodiment of a fastener that passes through fastening hole 244.

The fastening holes 240 and 244 may be oblong and aligned to guide lateral movement of the sliding plate 220 and the primary spur gear assembly 210 toward and away from an engine to adjust a mesh between the primary spur gear 230 and a gear of the engine. The fastening holes 240 and 244 may be considered oblong because they are slightly larger than a width of the fastener in a first direction and significantly larger than a width of the fastener in a second direction perpendicular to the first direction to substantially restrict the lateral movement of the fastener relative to the chassis and engine to the second direction. The holes may be considered slightly larger than a width of the fastener when they are less than twice the width of the fasteners and/or the fasteners are able to secure the sliding plate 220 in place on the chassis because of how narrow the fastening holes 240 and 244 are relative to the fasteners. The holes may be considered significantly larger than the width of the fasteners in a second direction perpendicular to the first direction when the holes are longer than twice the width of the fasteners, the holes are visibly longer in the second direction than they are wide in the first direction, and/or the holes facilitate sufficient movement of the sliding plate 220 relative to the chassis along the second direction to measurably adjust the mesh between the primary spur gear 230 and the gear of the engine without detrimental skewing of the sliding plate 220 along the first direction.

The throttle/brake servo 280 controls a throttle of an engine to be coupled with the primary spur gear assembly 210 and/or brakes. Throttle/brake linkage assembly 290 includes a throttle rod assembly 292 that links the throttle/brake servo 280 to the engine, a throttle servo turnbuckle 294 that links the throttle/brake servo 280 to the primary spur gear assembly 210, and two brake rod assemblies 296 and 298 that link the throttle/brake servo 280 to brake levers. The throttle/brake servo 280 is included in the sliding assembly 200 so that its position relative to the primary spur gear assembly 210 is fixed. This ensures that the linkages between the throttle/brake servo 280 and the brake levers do not change when the gear mesh between the primary spur gear assembly 210 and the engine is adjusted.

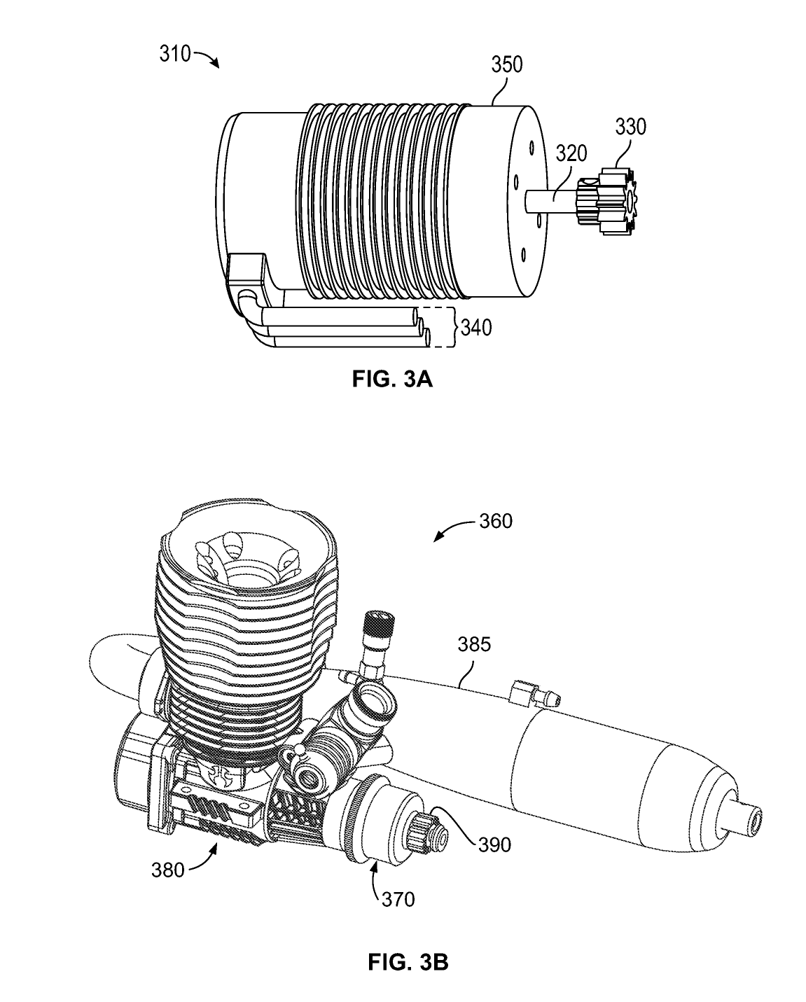

FIG. 3A is a view that illustrates an electric motor assembly 310, according to an embodiment. The electric motor assembly 310 includes an electric motor 350, an axle 320, a drive gear 330, and electric connections 340. When the electric motor 350 is controlled and powered through electric connections 340 to run, the electric motor 350 turns the axle 320 and the drive gear 330. The drive gear 330 may be fixed in position relative to the electric motor 350. The drive gear 330 may mesh with the primary spur gear 130 of the primary spur gear assembly 110 and thereby turn the axles 150.

FIG. 3B is a view that illustrates an engine assembly 360, according to an embodiment. The engine assembly 360 includes an engine 380, an exhaust and muffler 385, a clutch 370, and a drive gear 390. The drive gear 390 may be fixed in position relative to the engine 380. The engine may be a combustion engine, for example, a nitro engine. When the engine 380 is controlled to run, the engine 380 turns the drive gear 390 via the clutch 370. The drive gear 390 may mesh with the primary spur gear 230 of the primary spur gear assembly 210 and thereby turn the axles 250.

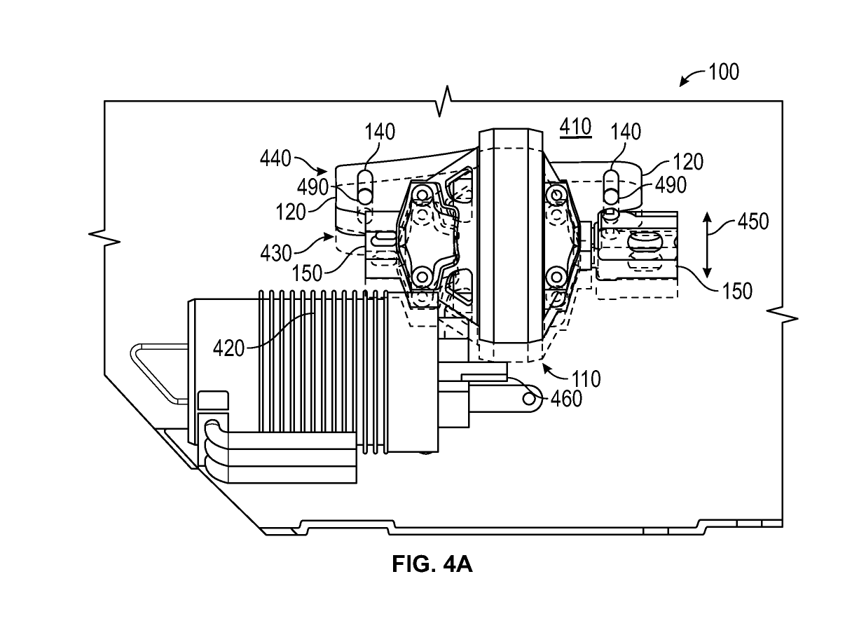

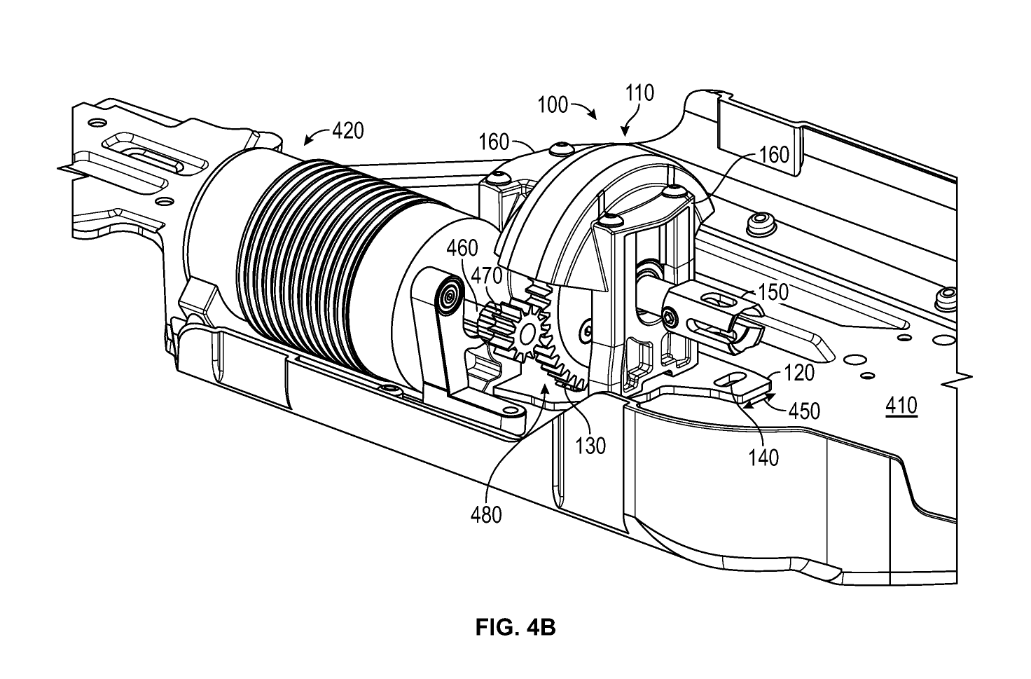

FIG. 4A is a top view that illustrates two alternate positions of a sliding assembly 100 mounted on a chassis 410 and coupled with a motor 420 fixed in relation to the chassis 410, according to an embodiment. FIG. 4B is an angled view that illustrates the sliding assembly 100 mounted on the chassis 410 and coupled with the motor 420 fixed in relation to the chassis 410, according to an embodiment. The motor 420 may be an embodiment of the electric motor 350. The sliding assembly 100 including the sliding plate 120 is shown in two positions, one position 430 slid toward the motor 420, and one position 440 slid away from the motor 420. The sliding assembly 100 can be variably positioned anywhere along a continuum of positions from a near position, e.g., position 430, and a far position, e.g., position 440. The sliding assembly 100 can move along an adjustment direction 450 relative to the chassis 410 to adjust gear mesh 480 between the primary spur gear 130 and the drive gear 470 that is coupled with the motor 420 via drive axle 460. The motor 420 is fixed in relation to the chassis 410.

In an embodiment, in order to adjust the gear mesh 480, sliding assembly fasteners 490 are loosened to enable the sliding plate 120 to slide toward or away from the motor 420 along the direction 450, the sliding plate 120 is then slid toward or away from the motor 420 along the direction 450 to adjust the gear mesh 480, and then the sliding assembly fasteners 490 are tightened to hold the sliding plate 120 and the sliding assembly 100 in place relative to the chassis 410. The sliding assembly fasteners 490 may include screws, bolts, rivets, knobs, pins, protrusions, or other fasteners as known in the art to releasably fasten two plates that slide relative to one another together. Other fasteners that may replace or supplement the fasteners 490 include nuts, levers, clamps, clips, latches, and toggle fasteners. For example, in some embodiments, a latch or lever may be used to fasten the sliding plate 120 in position relative to the chassis 410, while a protrusion extends from the chassis 410 through the fastening hole 140, 142, and/or 144 to guide the sliding plate 120 while the sliding plate 120 is adjusted toward or away from the motor 420 along the adjustment direction 450.

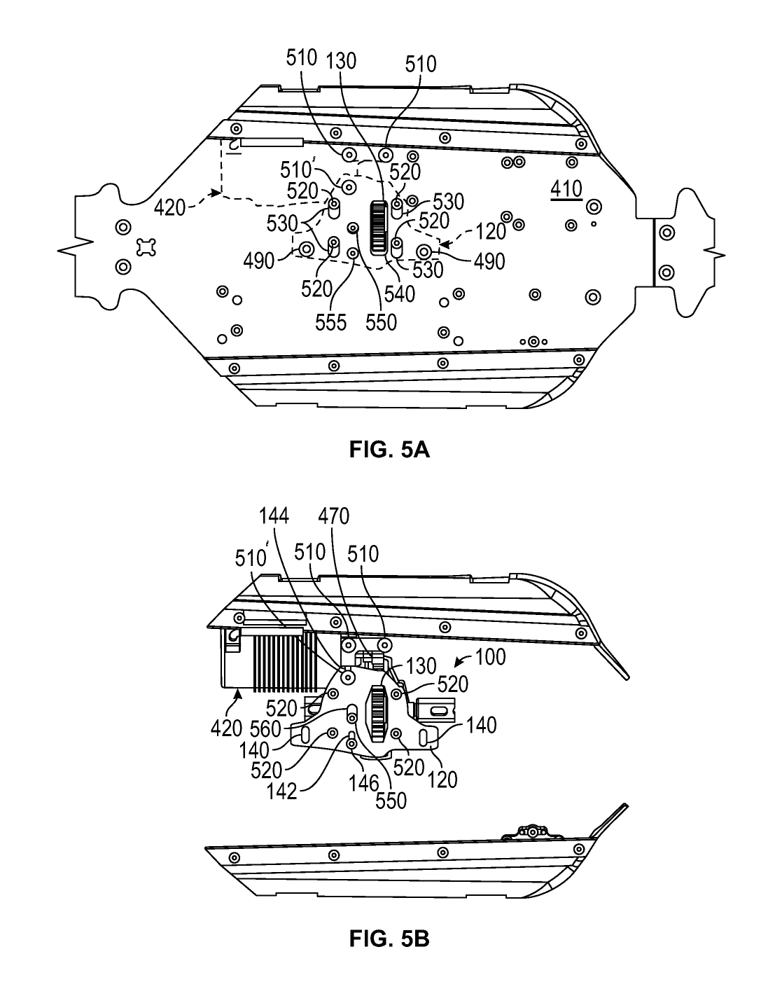

FIG. 5A is a bottom view that illustrates a bottom of the chassis 410 with which the sliding assembly 100 and the motor 420 of FIGS. 4A and 4B are coupled, according to an embodiment. FIG. 5B is a bottom view with the chassis 410 removed showing the relative positions of the sliding assembly 100 and the motor 420 of FIGS. 4A and 4B when they are coupled with the chassis 410, according to an embodiment. Motor mount fasteners 510 and 510′ (e.g., screws, rivets, or other fasteners as disclosed elsewhere herein or known in the art) are fixed in position on the chassis 410 through circular holes. Motor mount fastener 510′ also holds the sliding plate 120 in position on the chassis 410 when tightened, and facilitates lateral movement of the sliding plate 120 toward and away from the drive gear 470 coupled with the motor 420 when loosened. Sliding assembly protrusions 520 guide lateral movement of the sliding plate 120 toward or away from the drive gear 470 by passing through oblong holes 530 in the chassis 410. Although the motor mount fasteners 510 and 510′ are described as being fixed in position through circular holes in the chassis, this should not be construed as limiting. The holes in the chassis 410 through which the fasteners 510 and 510′ are fixed in position may comprise other substantially symmetrical shapes, for example, triangular, square, diamond, pentagonal, hexagonal, heptagonal, octagonal, or other shapes that hold the fasteners 510 and 510′ in position with about as little lateral movement in each direction as in all other directions. The substantially symmetrical holes may be slightly larger than a width of the fasteners 510 and 510′ to constrain lateral movement of the fasteners 510 and 510′ relative to the chassis. In addition to the sliding assembly fasteners 490, sliding assembly fastener 146 may be loosened to enable the sliding plate 120 to slide toward or away from the motor 420 along the direction 450, and the sliding assembly fastener 146 may be tightened to hold the sliding plate 120 and the sliding assembly 100 in place relative to the chassis 410. Like the sliding assembly fasteners 490, the sliding assembly fastener 146 may include screws, bolts, rivets, protrusions, or other fasteners as known in the art to releasably fasten two plates that slide relative to one another together. The sliding assembly fastener 146 protrudes through oval or oblong fastening hole 142 in the sliding plate 120.

Protrusion 550 passes through oval or oblong hole 560 in the sliding plate 120 to guide the sliding plate 120 in sliding toward or away from the motor 420 along the direction 450. The primary spur gear 130 protrudes through an opening 540 in the chassis 410.

The motor mount fasteners 510 and 510′ fix the motor 420 in position relative to the chassis 410 when the motor 420 is mounted using the motor mount holes. Because the oblong holes 530 are oblong, the sliding assembly 100 having sliding assembly protrusions 520 that are seated in the oblong holes 530 may be adjusted in position relative to the chassis 410 toward or away from an axis of rotation of the motor 420 mounted using the motor mount holes, thereby moving the primary spur gear 130 toward or away from the axis of rotation of the motor 420.

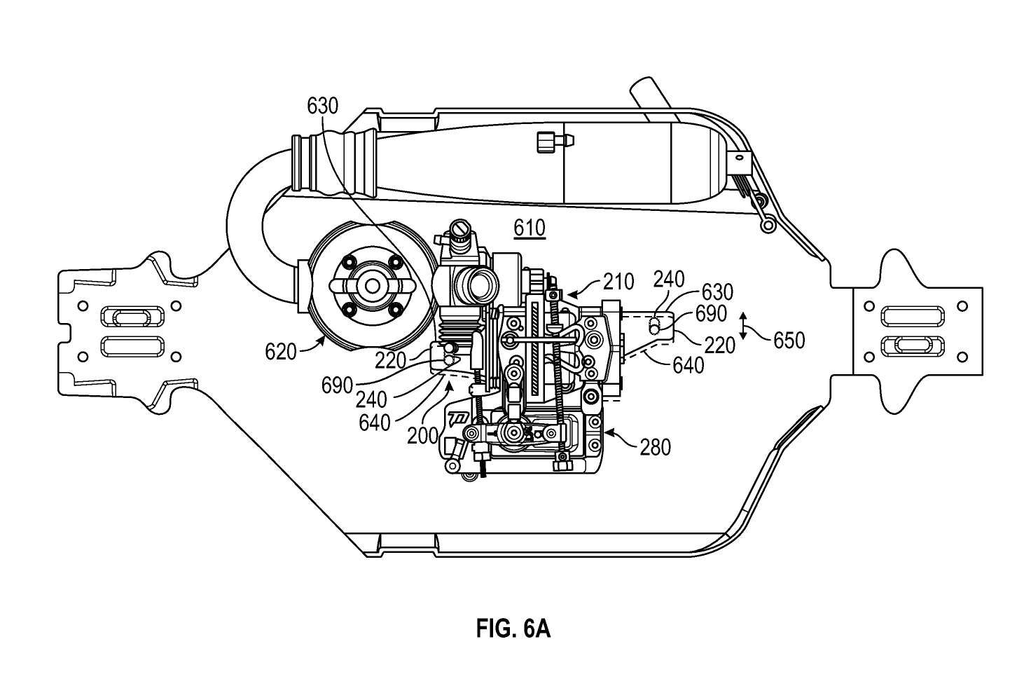

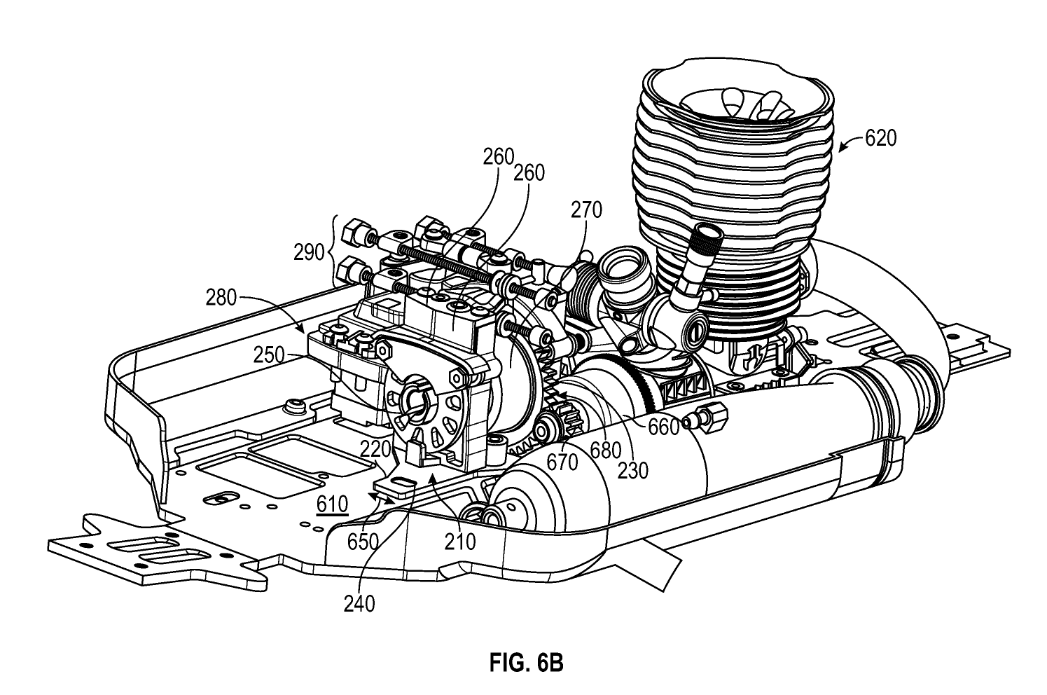

FIG. 6A is a top view that illustrates two alternate positions of a sliding assembly 200 mounted on a chassis 610 and coupled with an engine 620 fixed in relation to the chassis 610, according to an embodiment. FIG. 6B is an angled view that illustrates the sliding assembly 200 mounted on the chassis 610 and coupled with the engine 620 fixed in relation to the chassis 610, according to an embodiment. The engine 620 may be an embodiment of the engine 380. The sliding assembly 200 including the sliding plate 220 is shown in two positions, one position 630 in which the sliding plate 220 is slid toward the engine 620, and one position 640 in which the sliding plate 220 is slid away from the engine 620. The sliding assembly 200 can be variably positioned anywhere along a continuum of positions from a near position, e.g., position 630, and a far position, e.g., position 640. The sliding assembly 200 can move along an adjustment direction 650 relative to the chassis 610 in order to adjust gear mesh 680 between the primary spur gear 230 and the drive gear 670 that is coupled with the engine 620 via clutch 660. The engine 620 is fixed in relation to the chassis 610.

In an embodiment, in order to adjust the gear mesh 680, sliding assembly fasteners 690 are loosened to enable the sliding plate 220 to slide toward or away from the engine 620 along the direction 650, the sliding plate 220 is then slid toward or away from the engine 620 along the direction 650 to adjust the gear mesh 680, and then the sliding assembly fasteners 690 are tightened to hold the sliding plate 220 and the sliding assembly 200 in place relative to the chassis 610. The sliding assembly fasteners 690 may include screws, bolts, rivets, knobs, pins, protrusions, or other fasteners as known in the art to releasably fasten two plates that slide relative to one another together. Other fasteners that may replace or supplement the fasteners 690 include nuts, levers, clamps, clips, latches, and toggle fasteners. For example, in some embodiments, a latch or lever may be used to fasten the sliding plate 220 in position relative to the chassis 610, while a protrusion extends from the chassis 610 through the fastening holes 240 and/or 244 to guide the sliding plate 220 while the sliding plate 220 is adjusted toward or away from the engine 620 along the adjustment direction 650.

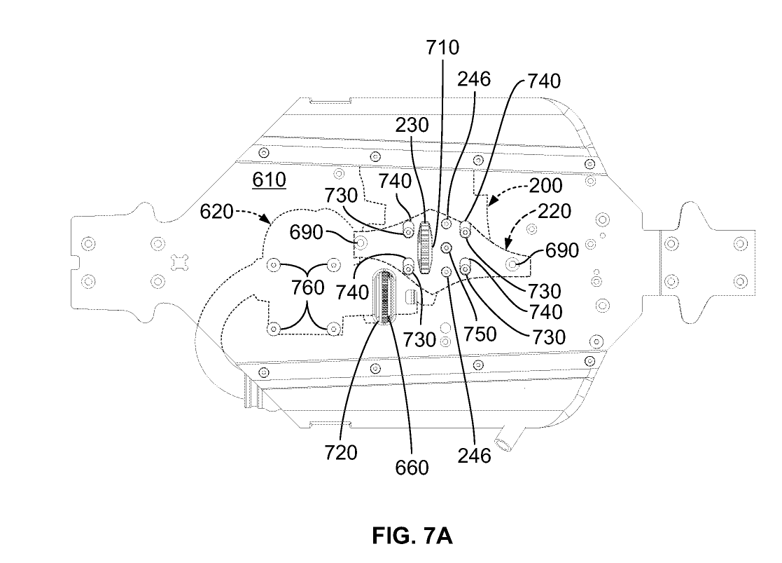

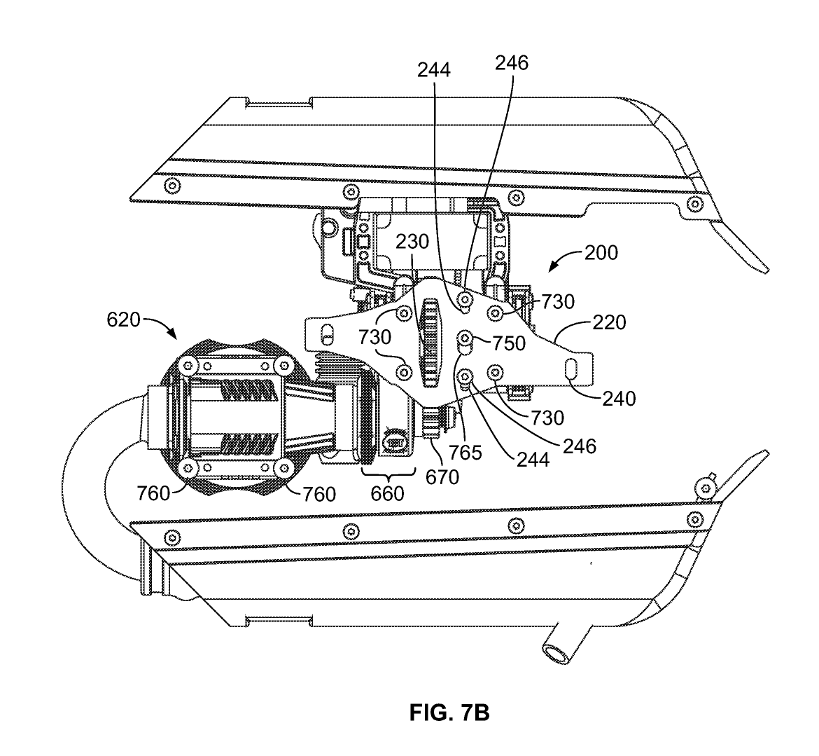

FIG. 7A is a bottom view that illustrates a bottom of the chassis 610 with which the sliding assembly 200 and the engine 620 of FIGS. 6A and 6B are coupled, according to an embodiment. FIG. 7B is a bottom view with the chassis 610 removed showing the relative positions of the sliding assembly 200 and the engine 620 of FIGS. 6A and 6B when they are coupled with the chassis 610, according to an embodiment. Engine mount fasteners 760 (e.g., screws, rivets, or other fasteners as disclosed elsewhere herein or known in the art) are fixed in position on the chassis 610 through circular holes. Sliding assembly protrusions 730 guide lateral movement of the sliding plate 220 toward or away from the drive gear 670 coupled with the engine 620 by passing through oblong holes 740 in the chassis 610. Although the engine mount fasteners 760 are described as being fixed in position through circular holes in the chassis, this should not be construed as limiting. The holes through which the fasteners 760 are fixed in position may comprise other substantially symmetrical shapes, for example, triangular, square, diamond, pentagonal, hexagonal, heptagonal, octagonal, or other shapes that hold the fasteners 760 in position with about as little lateral movement in each direction as in all other directions. The substantially symmetrical holes may be slightly larger than a width of the fasteners 760 to constrain lateral movement of the fasteners 760 relative to the chassis. In addition to the sliding assembly fasteners 690, sliding assembly fasteners 246 may be loosened to enable the sliding plate 220 to slide toward or away from the engine 620 along the direction 650, and the sliding assembly fasteners 246 may be tightened to hold the sliding plate 220 and the sliding assembly 200 in place relative to the chassis 610. Like the sliding assembly fasteners 690, the sliding assembly fasteners 246 may include screws, bolts, rivets, protrusions, or other fasteners as known in the art to releasably fasten two plates that slide relative to one another together. The sliding assembly fasteners 246 protrude through oval or oblong fastening holes 244 in the sliding plate 220.

Protrusion 750 passes through oval or oblong hole 765 in the sliding plate 220 to guide the sliding plate 220 in sliding toward or away from the engine 620 along the direction 650. The primary spur gear 230 protrudes through an opening 710 in the chassis 610, while a gear of the clutch 660 protrudes through an opening 720 in the chassis 610.

The engine mount fasteners 760 fix the engine 620 in position relative to the chassis 610 when the engine 620 is mounted using the engine mount holes. Because the oblong holes 740 are oblong, the sliding assembly 200 having sliding assembly protrusions 730 that are seated in the oblong holes 740 may be adjusted in position relative to the chassis 610 toward or away from an axis of rotation of the engine 620 mounted using the engine mount holes, thereby moving the primary spur gear 230 toward or away from the axis of rotation of the engine 620.

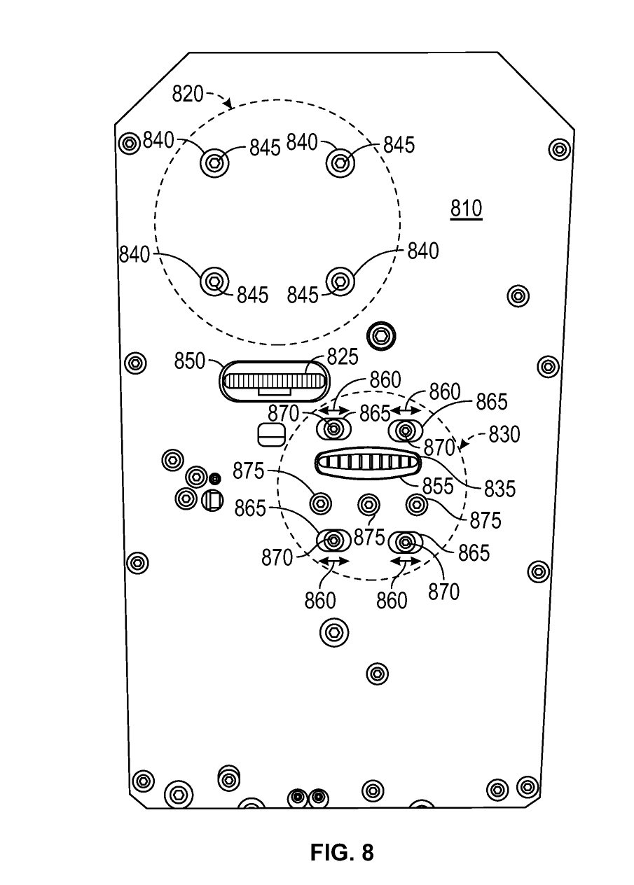

FIG. 8 is a bottom view that illustrates a bottom of a chassis 810 with which a sliding assembly 830 and a prime mover 820 are coupled, according to another embodiment. The sliding assembly 830 may be an embodiment of the sliding assembly 100 or 200, and the prime mover 820 may be an embodiment of the electric motor 350, electric motor 420, engine 380, or engine 620. The sliding assembly 830 may include a center differential. Protrusions 870 pass from the sliding assembly 830 through oblong holes 865 in the chassis 810 and guide the sliding assembly 830 along adjustment direction 860 in order to move the sliding assembly 830 and the primary spur gear 835 toward or away from an axis of rotation of the prime mover 820. The primary spur gear 835 may protrude through an opening 855 in the chassis 810. One or more fasteners 875 may pass through corresponding oblong openings in the sliding assembly 830 in order to guide the sliding assembly 830 as the sliding assembly 830 moves toward and away from an axis of rotation of the prime mover 820 along adjustment direction 860, and to fasten the sliding assembly 830 in position relative to the chassis 810. The prime mover 820 is fixed in place in the chassis 810 by fasteners 845 that attach through circular holes 840. Although the holes 840 are described as being circular, this should not be construed as limiting. The holes 840 may comprise other substantially symmetrical shapes, for example, triangular, square, diamond, pentagonal, hexagonal, heptagonal, octagonal, or other shapes that hold the fasteners 845 in position with about as little lateral movement in each direction as in all other directions. The holes 840 may be slightly larger than a width of the fasteners 845 to constrain lateral movement of the fasteners 845 relative to the chassis 810. In embodiments in which the prime mover 820 includes a clutch 825, a gear of the clutch 825 may protrude through an opening 850 in the chassis 810.

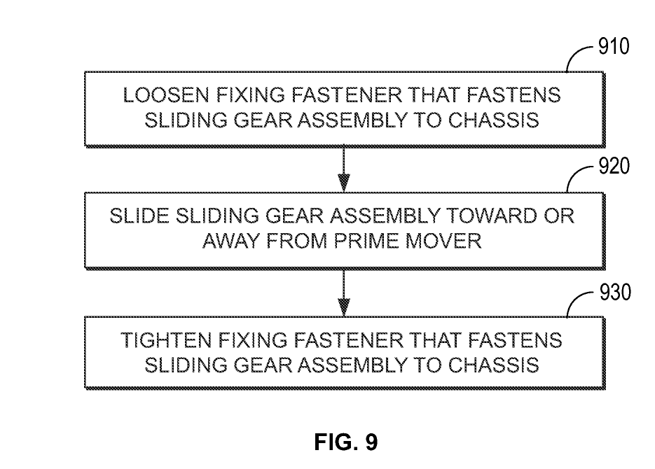

FIG. 9 is a flow chart of a method of adjusting a mesh between a prime drive gear of a prime mover and a sliding drive gear of a sliding gear assembly, according to an embodiment. The prime drive gear may be an embodiment of drive gear 330, drive gear 390, drive gear 470, or drive gear 670. The prime mover may be an embodiment of electric motor 350, engine 380, electric motor 420, engine 620, or prime mover 820. The sliding gear assembly may be an embodiment of the sliding assembly 100, sliding assembly 200, or sliding assembly 830. The sliding drive gear may be an embodiment of primary spur gear 130, primary spur gear 230, or primary spur gear 835. The mesh may be an embodiment of the gear mesh 480 or gear mesh 680. The prime mover may be mounted on a chassis and fixed in position relative to the chassis. The chassis may be an embodiment of the chassis 410, chassis 610, or chassis 810. The prime drive gear may be coupled with the prime mover and driven to rotate by the prime mover. The sliding gear assembly may include the sliding drive gear slidably mounted on the chassis to slide toward and away from the prime drive gear.

In a step 910, a fixing fastener that fastens a sliding gear assembly to a chassis is loosened. The fixing fastener may include a screw, a rivet, a bolt, a nut, a lever, a knob, a clamp, a clip, a latch, a toggle fastener, a pin, or other fasteners as known in the art. The fixing fastener may be an embodiment of sliding assembly fastener 146, sliding assembly fastener 246, sliding assembly fastener 490, and sliding assembly fastener 690.

In a step 920, the sliding gear assembly is slid toward or away from the prime mover. Sliding the sliding gear assembly may include sliding the fixing fastener along a length of an oblong hole in a sliding plate of the sliding gear assembly. The oblong hole may be an embodiment of fastening holes 140, 142, 144, 240, and 244. The oblong hole may be aligned to guide lateral movement of the sliding drive gear toward and away from the prime drive gear. While the embodiments disclosed herein include oblong holes to guide the lateral movement of the sliding drive gear toward and away from the prime drive gear, this should not be construed as limiting. In various other embodiments, lateral movement of the sliding gear assembly and the sliding drive gear toward and away from the prime drive gear may be accomplished by sliding the fixing fastener along a guide rail that is aligned to guide lateral movement of the sliding gear assembly and the sliding drive gear toward and away from the prime drive gear. For example, the guide rail may include a ridge or groove on either side of the fixing fastener or on either side of a sliding plate of the sliding gear assembly, for example, sliding plate 120 or 220. The guide rail may be disposed on either the chassis or on the sliding plate, in various embodiments.

In a step 930, the fixing fastener that fastens the sliding gear assembly to the chassis is tightened to complete the adjustment of the mesh between the prime drive gear of a prime mover and the sliding drive gear of a sliding gear assembly.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A sliding gear mesh comprising:
a chassis;
a prime mover mounted on the chassis and fixed in position relative to the chassis;
a prime drive gear coupled with the prime mover and driven to rotate by the prime mover; and
a sliding gear assembly comprising a sliding drive gear that meshes with the prime drive gear, the sliding gear assembly being slidably mounted on the chassis to slide toward and away from the prime drive gear to adjust the mesh between the sliding drive gear and the prime drive gear.

2. The sliding gear mesh of claim 1, wherein the prime mover comprises a motor.

3. The sliding gear mesh of claim 1, wherein the prime mover comprises an engine.

4. The sliding gear mesh of claim 1, wherein the sliding drive gear comprises a spur gear.

5. The sliding gear mesh of claim 1, wherein the sliding drive gear is rotationally coupled with an axle to rotate the axle about an axis of rotation when the sliding drive gear rotates about the same axis of rotation.

6. The sliding gear mesh of claim 1, wherein the sliding drive gear is rotationally coupled with a differential to rotate a pair of axles along a common axis of rotation when the sliding drive gear rotates.

7. The sliding gear mesh of claim 1, wherein the prime mover is fixedly mounted on the chassis by a plurality of fasteners.

8. The sliding gear mesh of claim 7, wherein the plurality of fasteners includes a fixing fastener that passes through a substantially symmetrical hole in the chassis.

9. The sliding gear mesh of claim 8, wherein the substantially symmetrical hole is slightly larger than a width of the fixing fastener to constrain lateral movement of the fixing fastener relative to the chassis.

10. The sliding gear mesh of claim 8, wherein the fixing fastener includes a fastener selected from the group consisting of a screw, a rivet, a bolt, a nut, a lever, a knob, a clamp, a clip, a latch, toggle fastener, and a pin.

11. The sliding gear mesh of claim 1, wherein the sliding gear assembly is mounted on the chassis by a fixing fastener.

12. The sliding gear mesh of claim 11, wherein the fixing fastener alternately fixes the sliding gear assembly in position relative to the chassis by friction between the chassis and the sliding gear assembly when the fixing fastener is in a tightened state and facilitates lateral movement of the sliding gear assembly relative to the chassis and prime drive gear when the fixing fastener is in a loosened state.

13. The sliding gear mesh of claim 11, wherein the fixing fastener passes through a substantially oblong hole in a sliding plate of the sliding gear assembly and fastens to the chassis, the fixing fastener alternately fixing the sliding gear assembly in position relative to the chassis when the fixing fastener is in a tightened state and facilitating lateral movement of the sliding gear assembly relative to the chassis and prime drive gear when the fixing fastener is in a loosened state.

14. The sliding gear mesh of claim 13, wherein the oblong hole is slightly larger than a width of the fixing fastener in a first direction and significantly larger than a width of the fixing fastener in a second direction perpendicular to the first direction to substantially restrict the lateral movement of the fixing fastener relative to the chassis and prime drive gear to the second direction.

15. The sliding gear mesh of claim 14, wherein the second direction is aligned to guide lateral movement of the sliding drive gear toward and away from the prime drive gear.

16. The sliding gear mesh of claim 11, wherein the fixing fastener includes a fastener selected from the group consisting of a screw, a rivet, a bolt, a nut, a lever, a knob, a clamp, a clip, a latch, toggle fastener, and a pin.

17. The sliding gear mesh of claim 1, wherein the prime drive gear is fixed in position relative to the prime mover.

18. A method of adjusting a mesh between a prime drive gear of a prime mover and a sliding drive gear of a sliding gear assembly, wherein the prime mover is mounted on a chassis and fixed in position relative to the chassis, the prime drive gear is coupled with the prime mover and driven to rotate by the prime mover, and the sliding gear assembly comprising the sliding drive gear is slidably mounted on the chassis to slide toward and away from the prime drive gear, the method comprising:
loosening a fixing fastener that fastens the sliding gear assembly to the chassis;
sliding the sliding gear assembly toward or away from the prime mover; and
tightening the fixing fastener that fastens the sliding gear assembly to the chassis.

19. The method of claim 18, wherein sliding the sliding gear assembly comprises sliding the fixing fastener along a length of an oblong hole in a sliding plate of the sliding gear assembly that is aligned to guide lateral movement of the sliding drive gear toward and away from the prime drive gear.

20. The method of claim 18, wherein sliding the sliding gear assembly comprises sliding the fixing fastener along a guide rail that is aligned to guide lateral movement of the sliding drive gear toward and away from the prime drive gear.
